(19) United States
(12) Patent Application Publication
(10) Pub. No.: US 2008/0142599 A1
(43) Pub. Date: Jun. 19, 2008

(54) Methods and systems to meter point-of-purchase conduct with a wireless communication device equipped with a camera

(76) Inventors: Michael Benillouche, Raanana (IL); Jean-Luc Mauduit, Neuilly Sur Seine (FR)

Correspondence Address: HANLEY, FLIGHT & ZIMMERMAN, LLC, 150 S. WACKER DRIVE, SUITE 2100, CHICAGO, IL, 60606, US

(21) Appl. No.: 11/713,952

(22) Filed: Feb. 28, 2007

Related U.S. Application Data
(60) Provisional application No. 60/870,532, filed on Dec. 18, 2006.

(51) Int. Cl. G06K 7/10

(52) U.S. Cl. 235/462.41

(57) ABSTRACT

Methods and systems to meter point-of-purchase conduct with a wireless communication device equipped with a camera are disclosed. An example method includes receiving purchased product information from a camera-enabled telephone and receiving at least one of user demographics or user identification information from the camera-enabled telephone. The example method also includes receiving point-of-purchase information from the camera-enabled telephone.

### RELATED APPLICATIONS

This patent claims priority from U.S. Provisional Patent Application Ser. No. 60/870,532, filed Dec. 18, 2006, which is incorporated herein by reference in its entirety.

### FIELD OF THE DISCLOSURE

This disclosure relates generally to consumer purchasing behavior and, more particularly, to methods and systems to meter point-of-purchase conduct with a wireless communication device equipped with a camera.

### BACKGROUND

Understanding purchasing behavior of shoppers is important to market research entities seeking to provide accurate purchase conduct data to clients, such as manufacturers of goods, advertisers, service providers, and/or merchants (e.g., retailers, wholesalers, etc.). Such conduct data is typically used by the manufacturers, service providers, and/or merchants to develop effective marketing and/or advertising strategies. Additionally, empirical data related to shopper conduct may allow these entities to understand the degree of effectiveness of any implemented marketing and/or advertising strategy.

Many merchants cooperate with market research entities to provide point-of-purchase information. In some instances, the market research entity may contract with one or more merchants to acquire the point-of-purchase data for a fee. However, some of the received data may not reflect actual consumer purchase conduct with an acceptable degree of accuracy. For example, a cashier may fail to individually scan a barcode of each item purchased by a consumer and, instead, may scan a single item and multiply that item by the number purchased. Therefore, if the consumer purchased six (6) boxes of gelatin, the cashier may scan the first box and multiply the quantity purchased by six. As a result, data provided to the market research entity fails to include accurate detail relating to which specific flavors and/or verities of gelatin are selling better or worse. Further, such point-of purchase data is often not tied to specific purchasers and, thus, provides little or no demographic data.

To address such inaccuracies, market research entities may identify statistically selected households to participate in purchase conduct studies. Each household selected may reflect one or more demographic sub-group(s) of interest in an effort to obtain data that is statistically significant. Typically, members of the statistically selected household perform their shopping tasks and then, upon returning home, identify what items were purchased, where the items were purchased, how much they paid for each item, etc. This identification may be done manually or, in the case of the ACNielsen Homescan™, via a dedicated barcode scanner provided to the panelist for scanning the universal product code (UPC) on each purchased product. Unfortunately, the household members may find such data entry and/or scanning procedures to be tedious, thereby adversely impacting participation (e.g., panelists may intentionally or accidentally not scan one or more purchased items). Additionally, the household members may, for example, forget where some of the items were purchased and/or how much the items cost, particularly when their shopping tasks include numerous stores and significant time elapses from the purchase event and the data entry event.

### BRIEF DESCRIPTION OF THE DRAWINGS

FIG. 1 is a block diagram illustrating an example barcode image capture system that is configured to acquire consumer purchasing behavior data with a plurality of wireless communication devices.

FIG. 2 depicts an example table that may be used to store a list of stores and merchants in proximity to the wireless communication device.

FIG. 3 depicts an example table that may be used to store a list of stores preferred by the example consumer.

FIG. 4 illustrates an example camera-enabled wireless telephone that may be used to acquire consumer purchase information.

FIGS. 5-17 and 18A-18C illustrate example screenshots that may be displayed on the example camera-enabled wireless telephone of FIG. 4.

FIGS. 19A and 19B illustrate image capture using the example camera-enabled wireless telephone of FIG. 4.

FIGS. 20-24 illustrate additional example screenshots that may be displayed on the example camera-enabled wireless telephone of FIG. 4.

FIGS. 25-28 are flowcharts representative of example machine readable instructions that may be executed to acquire consumer purchasing behavior data.

FIG. 29 depicts an example web page that may be used to meter point-of-purchase conduct with a wireless communication device.

FIG. 30 is a block diagram of an example processor system that may be used to execute the example machine readable instructions of FIGS. 25-28 to implement the example systems and/or methods described herein.

### DETAILED DESCRIPTION

Although the following discloses example systems including, among other components, software executed on hardware, it should be noted that such systems are merely illustrative and should not be considered as limiting. For example, it is contemplated that any or all of these hardware and software components could be embodied exclusively in hardware, exclusively in software, exclusively in firmware, or in any combination of hardware, firmware, and/or software. Accordingly, while the following describes example systems, persons having ordinary skill in the art will readily appreciate that the examples provided are not the only way to implement such systems.

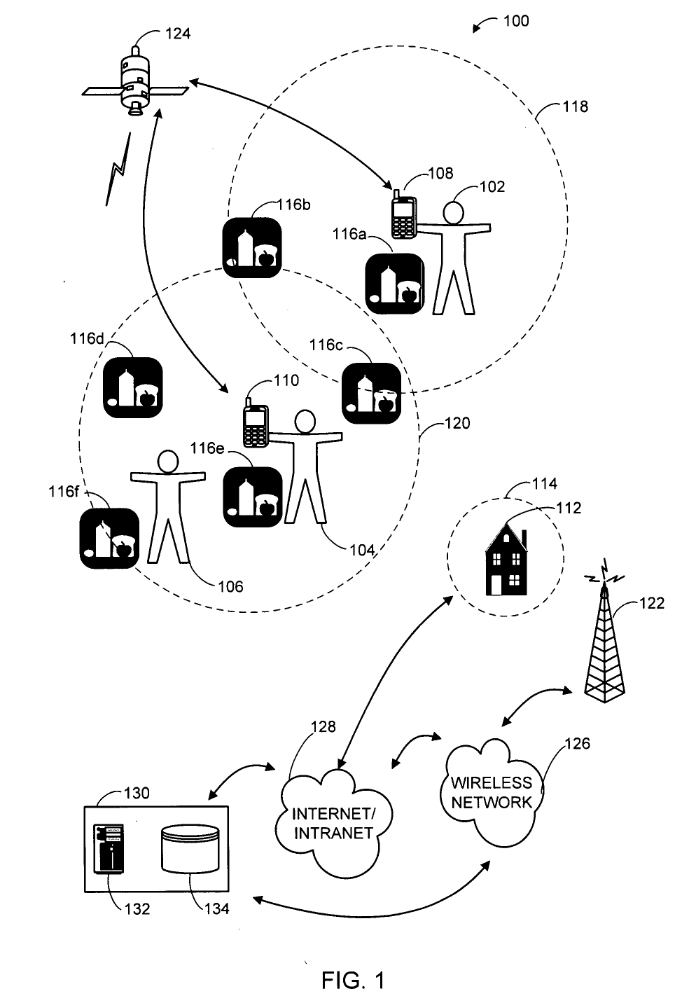

An example system 100 to meter point-of-purchase conduct with a wireless communication device is shown in FIG. 1. In general, the example methods and apparatus described herein enable metering of buying habits of a consumer using a camera-enabled wireless communication device. An example method of metering consumer buying habits with the camera-enabled wireless communication device includes capturing a product barcode image, associating the image with a purchase time, a purchase location, and/or a consumer, and sending purchase information to a metering entity to analyze the consumer purchase information. As discussed in further detail below, the consumer may perform data entry identifying product(s) purchased at or near the actual time of purchase, and/or may complete data entry of the same at a later time if more convenient for the consumer.

A barcode is a machine-readable representation of information (e.g., a universal product code (UPC), a serial number, etc.) presented in a visual format on a surface. Many items purchased in retail stores include a barcode identifier, such as a one-dimensional linear barcode, and/or a two-dimensional barcode (sometimes referred to as a “matrix code” or a “stacked code”). As used herein, the term “barcode” refers generally to any machine-readable identifier irrespective of whether the machine-readable identifier includes ‘bars’ in the literal sense. Such barcodes allow merchants to scan products (e.g., via a laser-scanner), product groups, and/or pallets of products for inventory tracking, customer behavior tracking, and/or billing purposes. Two-dimensional barcodes, on the other hand, cannot be read by a laser scanner and are, instead, captured by a camera-type device. Regardless of the type of capture device (e.g., a laser scanner, a camera, etc.), barcodes are usually employed to reduce purchase transaction times, to facilitate consumer behavior tracking (e.g., shopping trends), and/or to reduce merchant inventory times by allowing a relatively fast scan of a product without cumbersome human data entry procedure(s).

The wireless communication device of the illustrated example is a wireless telephone handset capable of capturing images with an embedded camera. Barcode images (e.g., one-dimensional, two-dimensional, etc.) of various types may be captured by the wireless telephone and processed either in the phone or at a back end device in communication with the phone to determine product identification details, such as, for example, a product manufacturer, a product type, a product size, a product quantity, a product barcode number, and/or a product stock keeping unit (SKU) or UPC identifier. A SKU or UPC is an identifier that is typically used by merchants/manufacturers to allow product and/or service tracking. The SKU and/or UPC may be associated with a single unit, with a particular product line, and/or with a particular sales bundle (e.g., a pre-packaged quantity of goods). For example, the wireless device of the illustrated example establishes connectivity with a wireless network (e.g., a wireless telephone network) and sends alpha-numeric indicia extracted from the captured image to a remote data source to search for a match. In the event that further processing still fails to return a match between the captured image and a product, the consumer may be invited to manually enter product details via the wireless communications device and/or via an Internet-enabled portal at a later time. For example, data entry at the time and point of purchase may be difficult in view of crowded shopping conditions, efficiency concerns, and/or time availability. While the wireless communication device automatically captures time and place information regarding a purchase, the consumer may, additionally or alternatively, manually enter further details for each item purchased (e.g., quantity purchased, price per unit, promotional information, etc.) after arriving home, for example, using the wireless communication device, and/or an Internet connected computer and website provided by the market research entity administering the example metering system 100.

In the illustrated example of FIG. 1, users of the camera-enabled wireless communication device receive incentives to participate in purchasing habit studies. For example, the marketing entity may offer the user the wireless communication device free of charge, reduced wireless phone rates, free minutes, rebates at stores, and/or cash rebates. Any or all of these rewards may be made proportional to the user's level of participation. Such incentives may be weighted so that greater incentive awards are granted when all purchase information is transmitted from the wireless communication device while the user is still at the point of purchase (e.g., in a store), and when the user has properly recorded all the items of purchase. However, lesser incentive awards are granted to a user that transmits point of sale information to the marketing entity at an alternate time and place. To enable any or all of these incentive promotions, the wireless device is structured to transmit its geographic (e.g., GPS) coordinates with the purchase information, or is structured to request that the user enter location information if, for example, the wireless device is not GPS-enabled. Similarly, the marketing entity may offer greater incentives if the consumer shops at particular stores, shopping malls, and/or purchases of specific product categories.

FIG. 1 is an example geographic area 100 in which the example methods, systems, and apparatus described herein may operate. However, the example methods, systems, and apparatus described herein may be used in any area or environment. The example geographic area 100 includes first, second, and third example users (102, 104, and 106, respectively). The term “user” will be used herein to generally refer to any of the first, second, and/or third example users (102, 104, 106, and/or other users not shown in FIG. 1). In the illustrated example, the first user 102 and second user 104 carry example first and second wireless communication devices (108 and 110, respectively), and the third user 106 does not carry a wireless communication device. Example users (102, 104, 106) may comprise family members that reside in an example household 112 and/or unrelated persons domiciled in different homes. The users 102, 104, 106 may be statistically related by a market research company to form one or more panels representative of one or more demographic groups of interest.

In the example of FIG. 1, the household is located within a household geography 114 and a plurality of example stores 116a-f are located within a first geographic area 118 and a second geographic area 120. First and second geographic areas 118, 120 may be defined by a cycle of a given radius drawn around the first and second wireless communication devices 108, 110 and, thus, may change with movement of the devices. The first and second wireless communication devices 108, 110, respectively, form first and second geographic areas 118, 120; each of which has, for example, a five-hundred foot radius. As discussed in further detail below, the example first and second wireless communication devices 108, 110 may maintain a list of stores and/or merchants within the first and/or second geographic areas 118, 120. The maintained lists may be periodically updated as the devices move.

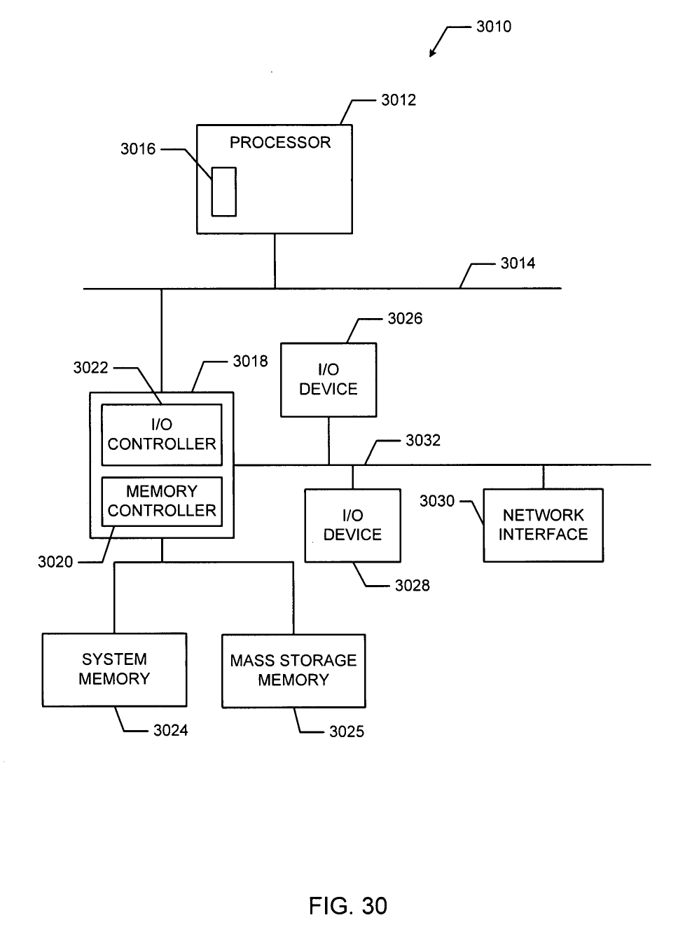

The wireless communication devices 108, 110 of the illustrated example employ any type of communication technique(s) and/or communication system(s) including, but not limited to, RF transceiver towers 122 (e.g., GSM, CDMA, TDMA, 3G, WI-FI antennas, etc.), and/or satellites 124. As discussed in further detail below, in the event that the example wireless communication devices 108, 110 of FIG. 1 are enabled with global positioning system (GPS) transceivers, users will be able to utilize satellites 124 to determine geographic location information. The example RF transceiver towers 122 are communicatively connected to a wireless network 126 of a service provider, such as a wireless telephone service provider and/or an Internet service provider. Additionally, the wireless network 126 is communicatively connected to an intranet and/or the Internet 128. Either the wireless network 126 and/or the Internet 128 may communicatively connect the wireless communication devices 108, 110 with an example central facility 130 via, for example, the RF transceiver towers. In the illustrated example, the central facility 130 includes a server 132 (e.g., a central processor system, a web server, a database query engine, etc.) and a database 134. The database 134 may be implemented using any suitable memory, or data storage apparatus and/or techniques. The server 132 may be implemented using, for example, a processor system similar or identical to the example processor system 3010 depicted in FIG. 30 that is configured to process, store, and/or provide information collected from the example wireless communication devices 108, 110.

In the illustrated example, the users 102, 104, 106 receive the wireless communication devices 108, 116 after entering into an agreement with a measurement entity (e.g., a market research company) to provide point-of-purchase data relating to shopping behavior. Alternatively, the wireless devices may be owned by the users and/or adapted to, for example, download appropriate software to the devices. The users may be selected for participation in any desired manner. For instance, the user may belong to households selected for measurement due to their demographic composition, income composition, and/or particular geographic proximity. In the illustrated example, the wireless communication devices 108, 110 (for example, camera-enabled wireless telephones) are mailed to the example users. Upon receipt, the user(s) may configure the wireless device(s) 108, 110 to display a list of merchants and/or stores that are most frequently visited by that user 102, 104, 106. To this end, the users 102, 104, 106 may need to enter user identification data such as, for example, current home location (e.g., address, city, state, country), age, name, gender, income, education, employment, preferred retailers/stores, preferred shopping locations and/or malls, and/or postal zip code. Persons of ordinary skill in the art will appreciate that data may be entered into a wireless device 108, 110 via the device's numeric keypad having alphabetic character selection capabilities. More specifically, the wireless devices 108, 110 of the illustrated example include a miniaturized keypad having alphanumeric keys, such as, for example, a “QWERTY” keyboard. Additionally or alternatively, the example users 102, 104, 106 may configure the wireless communication devices 108, 110 via a website maintained by the measurement entity. Upon user authentication, the users may access the web page and enter such configuration information by utilizing, for example, a full-size “QWERTY” keyboard. Without limitation, the measurement entity may pre-populate some or all of the known configuration information prior to sending the example wireless communication devices to the user(s) 102, 104, 106.

While shopping, the user 102, 104, 106 may utilize the example wireless communication device 108, 110 before, during, and/or after making a purchase from a store and/or merchant. In the illustrated example, the first, second, and third users (102, 104, 106) are shopping in a location (e.g., a shopping mall) having a plurality of stores 116a-f. The users may or may not be members of the same household and may or may not shop independently of one another. In the illustrated example, the first wireless communication device 108 is associated with a first geographic area 118 and the second wireless communication device 110 is associated with a second geographic area 120. As discussed above, each communication device 108, 110 may include a list of merchants and/or shops that are nearest the consumer's present location. In the illustrated example, the consumer may enter a city name or street address into a user-editable field of the communication device 108, 110 in which shopping will occur. As a result, the city information is transmitted from the communication device 108, 110 and received by the central facility 130. The central facility 130 employs the server 132 to query the example database 134 to search for known merchants and/or stores nearest the identified city or street address. Persons of ordinary skill in the art will appreciate that a more precise list may be provided from the central facility 130 to the wireless device 108, 110 when the user's present location is more accurately described. For example, the user 102, 104, 106 that provides a zip code and/or street address will generally receive more accurate data reflecting proximate stores than a user who enters a city name. Additionally or alternatively, communication devices 108, 110 that are provided with GPS capabilities may provide latitude and/or longitude coordinates to the central facility 130 that can be used to populate a list of proximate merchants for transmission to the example communication device 108, 110.

In the illustrated example, the first example user 102 makes a purchase at the store 116a and uses the wireless device 108 to capture an image of the barcode (e.g., a universal product code (UPC) barcode, a two-dimensional matrix, etc.) printed on or otherwise attached to the purchased product/item. The wireless device 108 processes the captured image to extract barcode identification information. In the event that the barcode is a one-dimensional UPC, the example wireless device 108 extracts the numeric code and populates a barcode field with the extracted numeric code. If the wireless device 108 cannot read the barcode, then the wireless device 108 may invite the consumer 102 to manually enter product identification data with the wireless device 108 immediately, or at a later time via the wireless device or another medium. To facilitate data entry, each purchase entry is associated with a pending commitment number or other identifier. Thus, rather than identify the purchase at the point-of-sale, the example consumer 102 may defer entering the purchase data until a later time (e.g., after returning home from the point of sale). The measurement entity webpage of the illustrated example allows the user 102 to enter the pending commitment number and view the corresponding pending entry. The user may then enter the point of sale information via the website. Upon completion of data entry via the product data entry webpage, the purchase is committed to the central facility 130 and the pending commitment number is deleted and/or deactivated.

In the illustrated example, one or more user screens in a menu-system are displayed on the wireless device 108 to facilitate data entry. For example, the user 102 may navigate one or more menus to allow the user to select the exact store in which the purchase is being made, the quantity of items being purchased, the price of the items, whether the items are being sold as a promotion, the type of promotion (e.g., coupon, price reduction, feature item, display model, etc.), and/or to which user 102, 104, 106 will actually use the purchased product (e.g., a gift, for personal use, for business use, etc.). In the illustrated example, the acquisition of purchase data, barcode image processing, and the display of instructional user screens (e.g., a graphical user interface (GUI) and/or webpage display(s) on the wireless device 108, 110 and/or another device such as a personal computer (PC) is performed by a process referred to below as a barcode image capture application.

As discussed in further detail below, after the user confirms that the captured barcode image corresponds to the purchased product, the user 108 confirms the purchase by committing the collected purchase information to the central facility 130. The illustrated example also shows the second example user 104 making a purchase at the store 116e using the second example wireless communication device 110. However, while the third example user 106 is shopping at the same mall as the other users 102, 104, that user 106 does not carry a wireless communication device to record point-of-purchase information when one or more products are purchased at the store 116f. Instead, the third example user 106 captures an image of purchased product(s) at a later time when, for example, returning home. The third user 106 may utilize his/her wireless device and/or a wireless communication device belonging to another user (e.g., device 108 or 110) to capture an image of the purchased product and commit the purchase to the central facility 130 at a later time. Unlike the first and/or second example user 102, 104 that commit various purchase information to the central facility 130 at or near the time of purchase, the third example user 106 must enter a date and/or time of purchase in the menu-system to correctly communicate that information to the central facility 130.

In another example, the example wireless communication devices 108, 110 utilize signals from a GPS satellite 124 to determine when a user 102 106 leaves his/her household geography 114. For example, when the user 102 is within his/her household 112, the wireless communication device 108 refrains from updating the list of proximate stores/merchants 116a-f. Preventing updates of proximate merchants and/or proximate store lists in this manner conserves the battery life of the example wireless communication device 108.

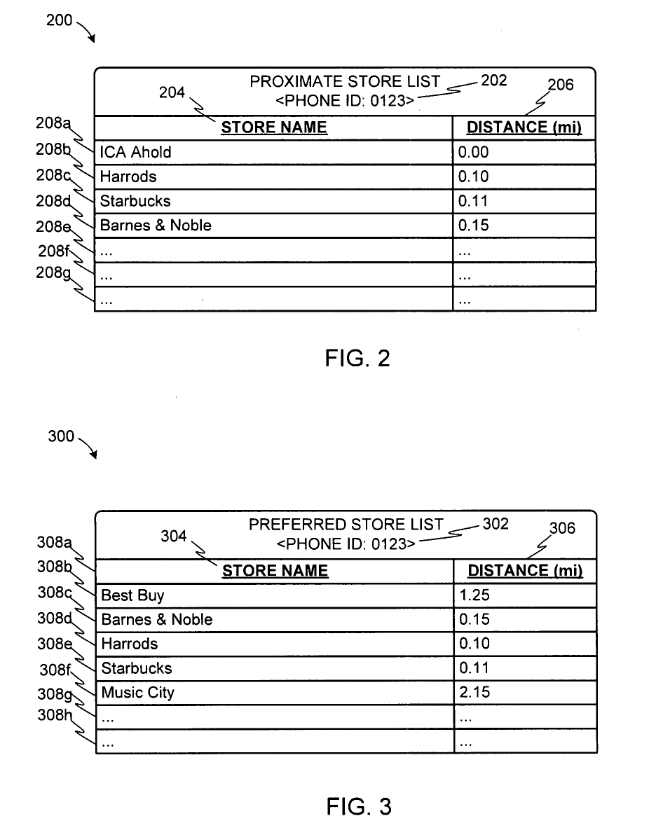

FIG. 2 illustrates an example table 200 listing proximate merchants/stores, hereinafter referred to as a “proximate store list.” The example proximate store list 200 is generated by the example database 134 and uploaded to the wireless communication device 108, 110 when, and/or if, necessary. For instance, the wireless communication device 108, 110 may receive an updated proximate store list only when corresponding GPS satellite 124 signals indicate that the wireless device 108, 110 has moved a sufficient distance to be considered to be in a new or alternate location. In the illustrated example, the proximate store list 200 is associated with a particular wireless communication device identifier 202, such as a telephone number and/or an electronic serial number (ESN) of a corresponding wireless device. The example proximate store list 200 of FIG. 2 includes a column to identify stores 204 and a column to identify a distance 206 between the corresponding store and the wireless communication device (108, 110) associated with the list 200. To facilitate data entry, the stores may be listed in an order reflecting proximity of the user to that store. Each row 208a-g identifies a particular store. If, for example, the first merchant on the list (i.e., “ICA Ahold”) is one in which the consumer is making a purchase, the consumer does not need to navigate through a long list of stores when performing point-of-purchase data entry and/or purchase commitment tasks. In the event that the user 102, 104, 106 requires an updated proximate store list 200, then the consumer 102, 104, 106 may enter a zip code, address, and/or phone number into a user editable field of the wireless device(s) 108, 110 that, when received by the central facility 130, returns an updated list of known merchants proximate the entered location information. Additionally or alternatively, the user may populate the merchant list that includes favorite and/or most frequently visited stores. This list may be synchronized with the database 134 of the central facility 130. Consumer participation may be maximized when data entry of consumer habits is simple and efficient.

Based on user preferences and/or configuration settings (e.g., a customized consumer profile), the user 102, 104, 106 may be presented with a preferred store list 300, as shown in FIG. 3. The example preferred store list 300 lists the user's favorite stores without regard to current proximity of the wireless device 108, 110. The preferred store list 300 may be more useful than the example proximate store list 200 of FIG. 2 with, for example, wireless communication devices 108, 110 that do not include GPS-enabled functionality and/or when the user opts to enter data at home rather than at the point of sale.

Returning to FIG. 1, when the example wireless device 108, 110 leaves its household geography 114, as determined by a user entry (e.g., a zip-code, address, and/or telephone number entered into the wireless device and transmitted to the central facility 130) and/or by GPS satellite 124 data, the device 108, 110 requests and/or receives an update of the list of proximate stores. For example, if the example user 102 leaves the household 112 and enters the store 116a, then the example proximate store list 200 will display the store name 204 associated with store/merchant 116a in which the user is located in row 208a (i.e., the nearest store listed first). Additionally, the example proximate store list 200 will display the store name 204 associated with the next nearest store/merchant 116b in row 208b (i.e., the second closest store in the second row), and the store name 204 associated with store/merchant 116c in row 208c (i.e., the third closest store in the third row). As a result, the consumer 102 may more efficiently indicate/enter the store in which a product was recently purchased. Additionally or alternatively, the household members 102, 104, 106 may update/inform the wireless devices 108, 110 with an indication that the members 102, 104, 106 are temporarily not participating (e.g., the user(s) are on vacation (e.g., holiday)), thereby preventing the wireless devices 108, 110 from updating the example proximate store list 200 via the GPS services associated therewith.

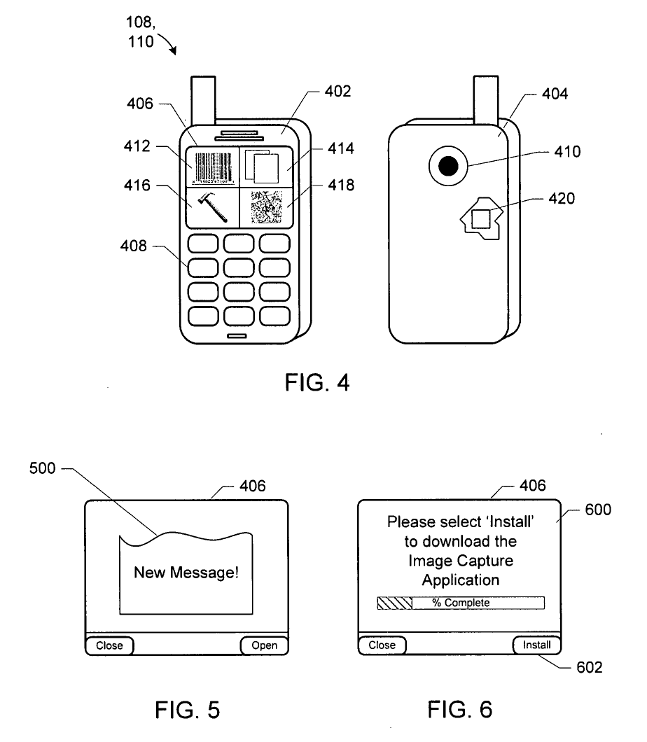

FIG. 4 illustrates an example implementation of either or both of the wireless communication devices 108, 110 described above. The wireless communication device 108, 110 may be, for example, a cellular telephone, a pager, a personal digital assistant (“PDA”), a handheld wireless computer, or any other wireless communication device having a camera to capture barcode images and communication capabilities to transfer information to/from the central facility 130. As described above, the example wireless communication device 108, 110 allows the user to manually enter location information and/or automatically detects the location of the device via one or more location detection devices, such as a GPS device and/or triangulation techniques involving detecting distances from cellular and/or transmission towers. In the illustrated example of FIG. 4, the wireless communication device 108, 110 is a wireless telephone (e.g., a cellular telephone). A service provider may facilitate communication with the example wireless telephone 108, 110 via various communication systems and/or techniques including, but not limited to, time division multiple access (“TDMA”) communication techniques, global system for mobile (“GSM®”) communication techniques, and/or code division multiple access (“CDMA”) communication techniques.

The example wireless telephone 108, 110 of FIG. 4 includes a front side 402, a back side 404, a display screen 406, a keypad 408, and a camera lens 410. The keypad 408 of the illustrated example includes alphabetic and/or numeric keys and may be implemented by, for example, a miniaturized QWERTY keypad. The display screen 406 allows the telephone 108, 110 user to navigate through various menus and/or submenus to utilize various features provided by the example telephone 108, 110. Such menus may include, but are not limited to text and/or pictures. The lens 410 may be adapted to employ a focal length that enables capturing of close range images, such as the SKUs, UPCs, and/or serial numbers located on various products. For example, the lens 410 may have a focal length of 41 millimeters (mm) to improve image reading and capture. Persons having ordinary skill in the art will appreciate that the lens 410 may be incorporated as an integral component of the example wireless telephone 108, 110, or be retrofitted to the example wireless telephone 108, 110 at a later time to enable barcode image capture. Additionally, the camera of the wireless telephone 108, 110 may employ various pixel resolutions, such as 1.3 mega-pixels (1280×960 pixels).

In the illustrated example, the display screen shows a barcode image 412, which may be selected by the user to enter a barcode scanning mode, a message image 414, which may be selected by the user to enter a messaging mode, an image of a hammer 416, which may be selected by the user to enter a tools mode, and a map image 418, which may be selected by the user to enter a GPS navigation mode. Additional or fewer telephone 108, 110 options may be present, depending on the make and/or model of the wireless telephone and/or the features supported by the wireless communication service provider. For instance, the example telephone 108, 110 may not include GPS functionality, and/or the display screen may include an image of a camera to allow the user to enter a camera-phone mode.

The example camera lens 410 allows the user of the wireless telephone 108, 110 to capture images to be stored and/or transmitted from the telephone 400. For example, the user may point the camera lens 410 at an object and/or scene while viewing such object and/or scene through the example display screen 406. In response to depressing a capture key (e.g., one of the keys on the keypad 408) on the front side 402 of the example telephone, the barcode scanning application is initiated. The scanning application employs an extractor 420 to decode the barcode and display the barcode number in the example display screen 406. Persons having ordinary skill in the art will appreciate that the extractor 420 may be implemented as a software application, a firmware application, and/or an application specific integrated circuit (ASIC). As discussed above, when the user is shopping with the wireless telephone 108, 110, the user employs the camera of the telephone 108, 110 to capture an image of the barcode on the product(s) purchased (or about to be purchased). The wireless telephone 108, 110 of the illustrated example then processes the captured barcode to extract numeric and/or alpha-numeric data from the barcode. The entered data is used to reference product identification data, such as the manufacturer of the scanned product, the product name, the product size, the product flavor, etc. The central facility 130 of the illustrated example employs a number of processing devices (e.g., servers) and databases to process the received numeric and/or alpha-numeric to identify corresponding product information. The product information may then be forwarded as text data (e.g., extensible markup language (“XML”) files) to the wireless telephone 108, 110.

FIGS. 5-18C and 20-24 illustrate example screenshots of the display screen 406 of the example wireless telephone 108, 110. In the illustrated example screenshots of FIGS. 5-18C and 20-24, the user makes selections from menu text and/or image prompts on the display screen 406 via one or more keys of the keypad 408 and/or one or more dedicated and/or programmable (e.g., “hot”) selection keys. The user and/or household of users may be contacted by the metering entity based on a random demographic sampling and/or as a result of a targeted marketing initiative. In some example implementations, selected individuals that agree to participate in the research program receive one or more new wireless telephones 108, 110 from the marketing entity. These telephones 108, 110 may include a pre-installed barcode image capture application. In the event that the user wishes to keep an existing compatible wireless telephone, or if the wireless telephone 108, 110 provided by the measurement entity does not have the barcode image capture application installed thereon, then the metering entity may transmit a text message 500 to the wireless telephone 108, 110, as shown in FIG. 5. In other words, the metering entity ‘pushes’ the application to the wireless telephone 108, 110 or causes a text message 500 to display on the wireless telephone 108, 110 that includes a URL to facilitate installation of the image capture application. In the illustrated example, opening the text message 500 results in a request screen 600, as shown in FIG. 6. If the user selects “Install” 602 from the example display screen 406 of FIG. 6, then the wireless telephone 108, 110 downloads and installs the image capture application. Persons of ordinary skill in the art will appreciate that this installation process is usually performed only once on a device.

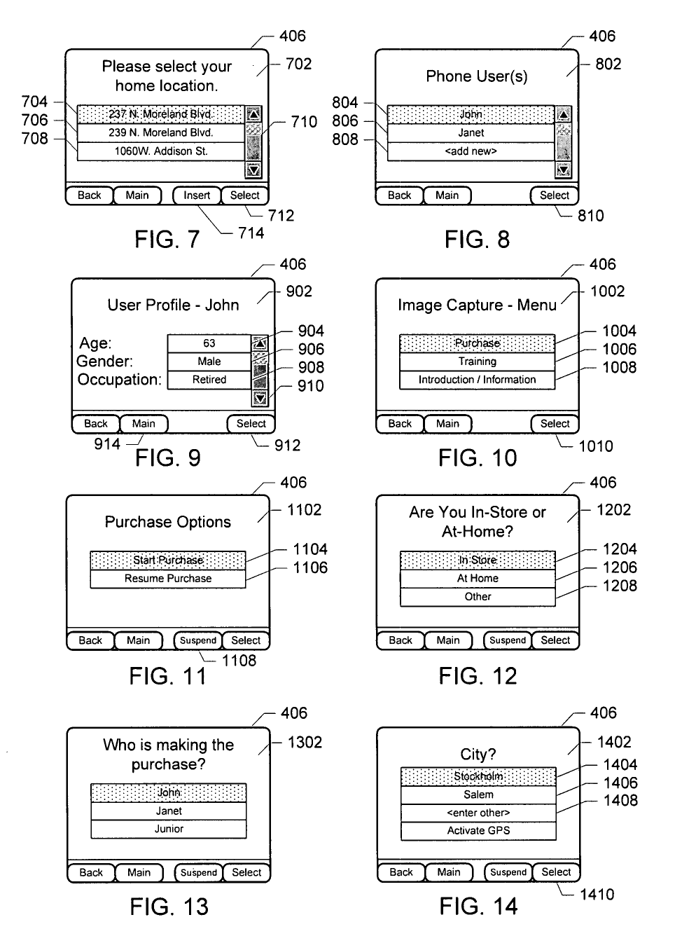

After the image capture application is installed on the example wireless telephone 108, 110, or if the image capture application is installed, but not configured, then the example display screen 406 presents the user with various configuration screens, as shown in FIGS. 7-9. In the illustrated example display screen 406 image of FIG. 7, the user is presented with a home location selection screen 702. If the example wireless telephone 108, 110 is equipped with GPS functionality, then the user may be presented with an address 704 of the current location of the telephone 108, 110. Persons of ordinary skill in the art will appreciate that GPS resolution may vary to such a degree that an exact matching street location determined by a GPS transceiver may not represent an exact location of the example telephone 108, 110. As such, the illustrated example display screen 406 lists several addresses 706, 708 nearest the identified location. Additional addresses may be accessed by the user by selecting a scroll bar 710. Choosing a “Select” icon 712 when the correct address has been identified stores the street location of the user. Alternatively, for an example telephone that does not employ GPS functionality, and/or if the user chooses not to employ GPS functionality, then the user may select an “Insert” icon 714 to manually enter an address, a zip-code, and/or other geographic identifier. In yet another example, the measurement entity may ship the example telephone 108, 110 to the user(s) with some of the configuration information already entered. In such examples, the display screen 406 home location selection screen 702 displays pre-populated address information thereon.

FIG. 8 illustrates an example phone user selection screen 802. During the configuration process, the phone user selection screen 802 of the illustrated example allows entry of all potential users of the example telephone 108, 110. For instance, an example household may comprise three users, such as “John” 804, “Janet” 806, and a third unlisted user named “Junior.” To accommodate a situation in which the household has more users than phones, all potential users of the example telephone 108, 110 may be entered into the telephone 108, 110. This many-to-one configuration capability allows the measurement entity to save money by sending fewer phones to a household, thereby taking advantage of acquiring useful measurement (e.g., marketing) data from more than one household user. As described above, the various household users may participate in the study in an effort to achieve various incentive levels/goals. Incentives may include, but are not limited to, free wireless phone minutes, free wireless device Internet connectivity, free messaging, rewards points for merchandise, and/or discount coupons for various merchants. As shown in FIG. 8, to accommodate all users of the household as potential users of the example wireless telephone 108, 110, the user navigates to the “<add new>” icon 808 and chooses the “Select” icon 810 to enter the name “Junior” via the example telephone 108, 110 keypad 408.

If the user highlights a name in the phone user selection screen 802 and selects the “Select” icon 810, then the user will be presented with a user profile configuration screen 902 in the example display screen 406, as shown in FIG. 9. Because the user highlighted “John” 804 and selected the “Select” icon 810 (see FIG. 8), corresponding profile fields related to household member “John” are presented on the display screen 406 shown in FIG. 9. Although the example user profile configuration screen illustrates an age field 904, a gender field 906, and an occupation field 908, additional fields may be accessed by the user by navigating a scroll bar 910. As described above, household user configuration information may include, but is not limited to, age, gender, occupation, income level, education, race, and/or preferred language. Persons of ordinary skill in the art will appreciate that, upon highlighting one of the various fields in the profile configuration screen 902, the user may select the “Select” icon 912 to edit the contents of the highlighted field. The example profile configuration screen 902, and/or any or all of the various screens displayed on the display screen 406 of the illustrated example includes a “Main” icon 914 to return the user to a main menu. From the main menu (not shown), the user may invoke the scanning application, as discussed in view of FIGS. 10-17 and 19-24.

FIG. 10 illustrates an example image capture menu 1002 displayed on the display screen 406 of the example wireless telephone 108, 110. In the illustrated example image capture menu 1002, the user navigates to and highlight a “Purchase” icon 1004, a “Training” icon 1006, or an “Introduction/Information” icon 1008. Upon the user highlighting an icon and selecting a “Select” icon 1010, a corresponding purchase, training, or introduction/information sub-menu is displayed to the user on the display screen 406 of the wireless telephone 108, 110. If the user highlights the “Purchase” icon 1004 and selects the “Select” icon 1010, a purchase options screen 1102 is displayed on the example display screen 406, as shown in FIG. 11. The user will typically select the “Purchase” icon 1004 when at a store before and/or after making a purchase. In the illustrated example purchase options screen 1102 of FIG. 11, the user is presented with a “Start Purchase” icon 1104 and a “Resume Purchase” icon 1106. As discussed in further detail below, selecting the “Start Purchase” icon 1104 initiates a purchase process in which the user captures an image of the product barcode. On the other hand, selecting the “Resume Purchase” icon 1106 allows the user to continue the scanning procedure in the event that the user was previously interrupted. For example, the user may initiate the image capture procedure, capture an image, and enter various fields of information related to the purchased product before being interrupted by an urgent telephone call on the example wireless device 108, 110. The interrupting telephone call may automatically suspend the image capture procedure and save any information entered by the user up to that point of interruption. Similarly, the user may choose to voluntarily suspend the image capture procedure due to an interruption by selecting a “Suspend” icon 1108. For example, the user may select the “Suspend” icon 1108 if a child requires attention/discipline, if the user engages in conversation with a store employee, and/or if the user is distracted by any other task and/or event. Additionally, the example wireless telephone 108, 110 may automatically suspend the image capture procedure after a predetermined amount of inactive time, which may suggest that the user has been interrupted.

If the user selects the “Start Purchase” icon 1104, as shown in FIG. 11, a location confirmation screen 1202 is presented to the user on the example display 406 of the wireless telephone 108, 110, as shown in FIG. 12. In the illustrated example location confirmation screen 1202 of FIG. 12, the user navigates to an area of the display screen 406 that corresponds to the user's location during data entry and/or image capture. Example location information of the example location confirmation screen 1202 includes “In Store” 1204, “At Home” 1206, and “Other” 1208. For example, if the user is present within the store when performing the image capture procedure, then the “In Store” icon 1204 is an appropriate user selection. However, if the store is, for example, extremely busy and/or the user is rushed through the buying process by the merchant, then the user may elect to complete the image capture procedure in a location other than the store, such as at home, on the train, in a cab, etc.

FIG. 13 illustrates an example purchaser identification screen 1302 displayed on the display screen 406 of the example wireless device 108, 110. In an example household in which each household user has a wireless device 108, 110, the purchaser identification screen 1302 may not be necessary. However, in situations where multiple household users share the wireless device, the current user may navigate the purchase identification screen 1302 to highlight the appropriate name. As such, the measurement entity may correlate purchasing behavior/habits with the appropriate demographic and/or other information associated with the user's profile.

FIG. 14 illustrates an example city identification screen 1402 displayed on the display screen 406 of the example wireless device 108, 110. In the illustrated example, the user selects the city in which the purchase is being made, or was previously made by navigating the city identification screen 1402 and highlighting the appropriate city name 1404, 1406. In the event that the appropriate city is not displayed on the city identification screen 1402, the user may highlight an “<enter other>” icon 1408 and choose the “Select” icon 1410 to manually enter a new city name using the phone's keypad. In another example, an example wireless telephone 108, 110 having GPS functionality may automatically determine the city in which the user is performing the scanning procedure. However, if GPS satellite signals are unable to reach the example wireless telephone 108, 110, or if the user is performing the scanning procedure at a later time and/or in an alternate city (e.g., resuming the purchase procedure), then the user may manually identify the city in which the purchase was made by highlighting the “<enter other>” icon 1408.

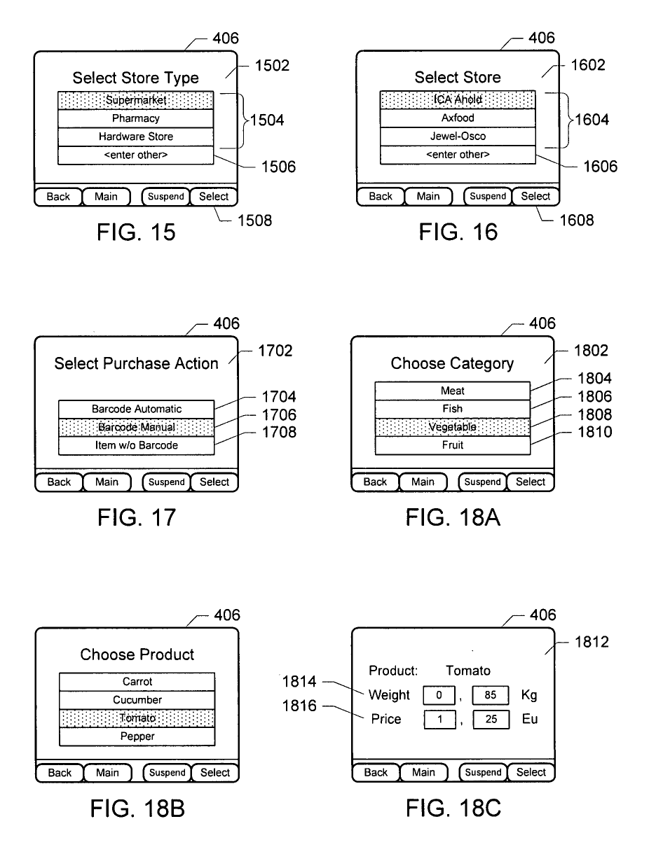

FIG. 15 illustrates an example store selection type screen 1502 displayed on the display screen 406 of the example wireless telephone 108, 110. In the illustrated example, the user selects from a list 1504 of various store types and/or enters a new store type by highlighting an “<enter other>” icon 1506 and choosing a “Select” icon 1508. FIG. 16 illustrates an example store name selection screen 1602 displayed on the display screen 406 of the example wireless telephone 108, 110. The user selects from a list 1604 of various store names and/or enters a new store name by highlighting an “<enter other>” icon 1606 and choosing a “Select” icon 1608. Persons of ordinary skill in the art will appreciate that, for an example wireless telephone 108, 110 having GPS functionality, the specific store in the list 1604 may be automatically selected based on the GPS location information obtained from the example GPS satellite 124. However, the example store name selection screen 1602 may still be necessary if many stores are relatively small and spaced closely together, thereby making GPS location resolution less certain. Accordingly, the example wireless telephone 108, 110 displays the list 1604 with stores of closest proximity and requests that the user select the correct store.

FIG. 17 illustrates an example select purchase action screen 1702 displayed on the display screen 406 of the example wireless telephone 108, 110. In the illustrated example of FIG. 17, the user is presented with a “Barcode Automatic” option 1704, a “Barcode Manual” option 1706, and an “Item without Barcode” option 1708. Such options 1704, 1706, 1708 allow the user to identify a purchased product by automatically processing a barcode image, by manually entering barcode information, and/or by entering product information for products that do not have a barcode printed thereon. For example, the “Barcode Manual” option 1706 allows the user to enter numeric and/or alphanumeric barcode data into the example wireless telephone 108, 110, such as a UPC number.

Alternatively, the “Item without Barcode” option 1708 permits the user to enter particular product information for purchased products that do not have a barcode printed thereon, or for products that use a non-official barcode specific to the store, such as fresh food items. In this case the user is selecting the item through a decision tree that allows navigation to a specific item. For example, “Fruits ⋄ Apples ⋄ Granny Smith.” FIG. 18A illustrates an example manual entry screen 1802 displayed on the display screen 406 of the example wireless telephone 108, 110. In the illustrated example of FIG. 18A, the user is presented with a decision tree to accommodate various items that do not include a barcode. For instance, while selectable options of “Meat” 1804, “Fish” 1806, “Vegetables” 1808, and “Fruits” 1810 are shown in the example display screen 406, persons of ordinary skill in the art will appreciate that the user may scroll to additional items within the menu. FIG. 18B illustrates an example menu layer of the decision tree to, for example, select a particular type of vegetable. Upon selecting the specific vegetable, the user is presented with a product purchase detail screen 1812, as shown in FIG. 18C. In the illustrated example display screen 406 of FIG. 18C, the user enters a vegetable weight in a weight data field 1814 and a vegetable price in a price data field 1816. In most instances, however, the user selects the “Barcode Automatic” option 1704, which invokes a camera application that executes on the example wireless telephone 108, 110.

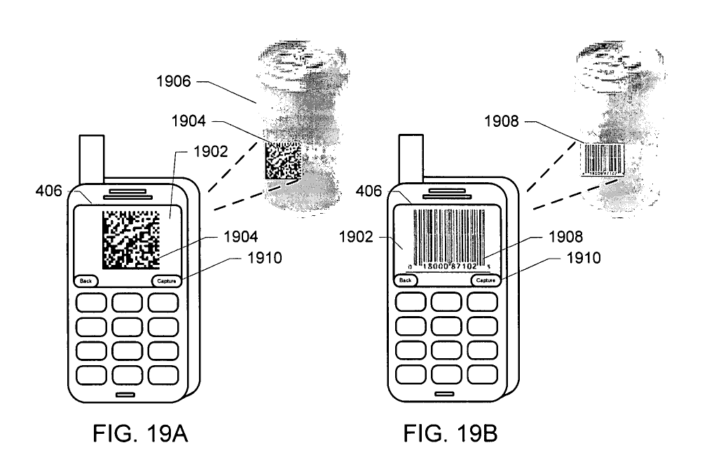

As shown in FIG. 19A, when the camera application executes to capture an image, the user is first presented with a live camera image 1902 in the display screen 406 of the example wireless telephone 108, 110. In the illustrated example of FIG. 19A, the barcode 1904 on an example product 1906 (e.g., a soda can) is of a two-dimensional matrix type. Without limitation, the barcode may be of a one-dimensional type, such as an example UPC barcode 1908, as shown in FIG. 19B. After the user manually centers an image of the barcode 1904, 1908 within the display screen 406, the user selects a “Capture” icon 1910 to decode the barcode number with the application.

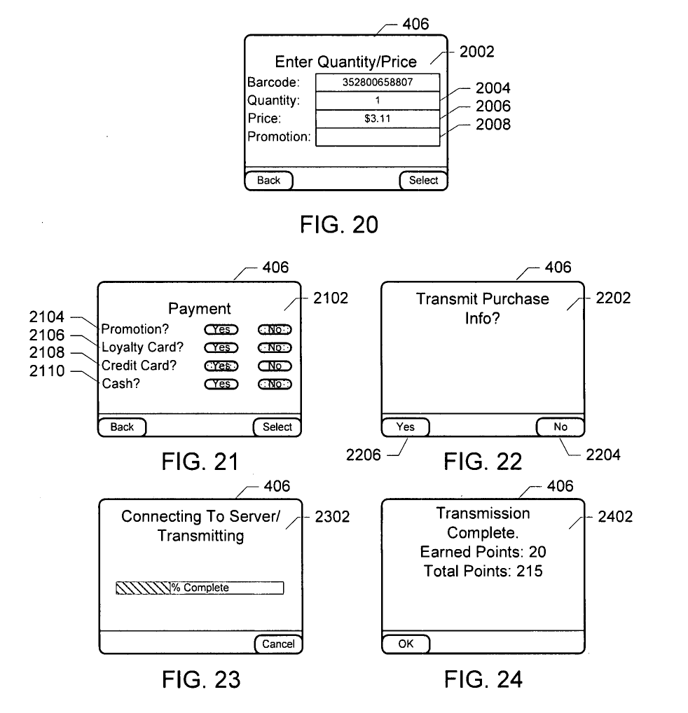

The user is presented with a quantity/price/promotion entry screen 2002 of the example display screen 406, as shown in FIG. 20. In the illustrated example, the user edits various fields to identify a quantity purchased 2004, a price 2006, and/or a promotion 2008. Without limitation, the example screen 2002 may allow the user to identify the intended user of the purchased product. Persons of ordinary skill in the art will appreciate that any other type of product identification information may be entered, including, but not limited to, expiration date, flavor, size, price per unit, and/or weight, and/or whether an extended warranty was purchased with the product.

FIG. 21 illustrates an example display screen 406 showing a payment identification screen 2102. In the illustrated example, the user navigates to the payment identification screen 2102 to indicate whether the product was purchased using a promotion 2104, a loyalty card 2106, a credit card 2108, or cash 2110. Additionally, users that select the promotion option 2104 or the loyalty card option 2106 may be further directed to example display screens that request additional information related to the particular promotion and/or loyalty card (e.g., discount received, loyalty card membership number, loyalty card points balance, loyalty points consumed for purchase, etc.).

Upon completion of user-editable data entry, the user is presented with a transmit screen 2202, as shown on the example display screen 406 of FIG. 22. If the user selects a “No” option 2204, then the example wireless telephone 108, 110 may store the previously entered information in the telephone memory so that the “Resume Purchase” option 1106 may be selected at a later time. Persons of ordinary skill in the art will appreciate that the example wireless telephone 108, 110 may not always have adequate signal strength for communication with RF towers 122, thus deferring transmission until an appropriate signal level is detected may reduce unnecessary power drain of the wireless telephone 108, 110. On the other hand, if the user selects the “Yes” option 2206, then the user is presented with a transmission status screen 2302 on the example display screen 406, as shown in FIG. 23. Upon completion of committing/transmitting the purchase information, which may include the product barcode image and/or other product related details, the user is presented with an awards update screen 2402 on the example display screen 406, as shown in FIG. 24. As described above, the measurement entity may provide user incentives so that participation by the household members is maximized. The earned incentives may be displayed in the awards update screen 2402.

Persons of ordinary skill in the art will readily appreciate that many other configurations and/or designs of the example screen shots of FIGS. 5-18C and 20-24 may alternatively be used. For example, the order of display of the screens may be changed, and/or some of the screens described may be changed, eliminated, and/or combined.

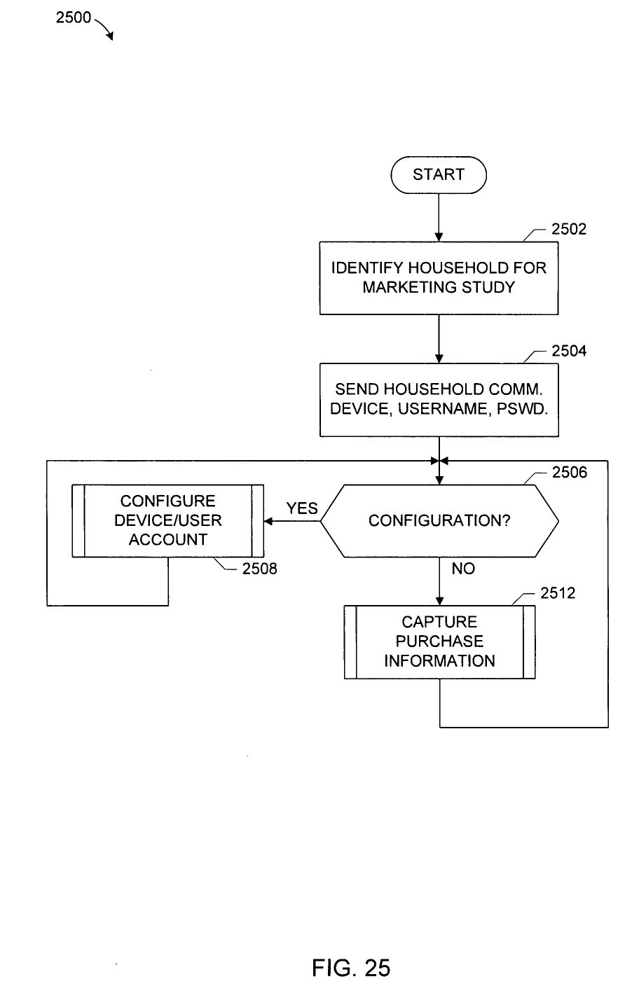

Flowcharts representative of example machine readable instructions for implementing the example wireless communication devices 108 and 110 of FIG. 1, the example camera-enabled wireless telephone 108, 110 of FIG. 4, and the example central facility 130 of FIG. 1, and/or other apparatus or systems (e.g., an interface executing on a personal computer in the example household 112 of FIG. 1) are shown in FIGS. 25 through 29. In the illustrated examples, the machine readable instructions comprise one or more programs for execution by one or more processors such as the processor 3012 shown in the example processor system 3010 of FIG. 30. The programs may be embodied in software stored on tangible mediums such as CD-ROM's, floppy disks, hard drives, digital versatile disks (DVD's), or a memory associated with the processor 3012 and/or embodied in firmware and/or dedicated hardware in a well-known manner. For example, any or all of the example wireless communication devices 108 and 110 of FIG. 1, the example camera-enabled wireless telephone 108, 110 of FIG. 4, the example central facility 130, server 132, and database 134 of FIG. 1, the example PC in the example household 112 of FIG. 1, and/or other example apparatus or systems described below could be implemented using software, hardware, and/or firmware. Further, although the example programs are described with reference to the flowcharts illustrated in FIGS. 25 through 29, persons of ordinary skill in the art will readily appreciate that many other methods of implementations may alternatively be used. For example, the order of execution of the blocks may be changed, and/or some of the blocks described may be changed, eliminated, or combined.

FIG. 25 is a flowchart representative of machine readable instructions 2500 that may be executed to obtain purchase behavior information and/or habits from users with a camera enabled wireless communication device. A measurement entity may initially identify suitable households to participate in one or more market study projects (block 2502). Selections of users and/or households, such as the example household 112 described in view of FIG. 1, to participate in the market study may be based on statistically significant demographic analysis and/or in response to advertisements for participant volunteers. The identified household 112 and/or user is provided with a camera-enabled wireless communication device (block 2504), such as the example wireless telephone 108, 110 discussed above in view of FIG. 4. Some measurement entities may send multiple camera-enabled wireless telephones to the identified household 112 (block 2504) in an effort to capture individual purchasing behavior from all of the household users, such as the example first user 102, the example second user 104, and/or the example third user 106. As such, each household user may have a unique profile to associate purchase data with the corresponding household user.

In another example, the measurement entity sends only one camera-enabled wireless telephone 108, 110 to a household having more than one user. For example, the measurement entity may find that providing multiple camera-enabled wireless telephones 108, 110 to all users of all identified households 112 is cost prohibitive. As such, each user of the identified household 112 may share a single wireless telephone 108, 110 when shopping, yet identify themselves with a unique profile stored on the wireless telephone 108, 110, which is the profile of the whole household.

In yet another example, the measurement entity sends vouchers to the identified household 112 to allow the household user(s) to purchase a compatible camera-enabled wireless telephone 108, 110 from a vendor of their choice. As such, the household users(s) may be provided with a web-address (e.g., a uniform resource locator (URL)), a username, and a temporary password. After the user obtains the compatible wireless telephone 108, 110, the user may register the wireless telephone 108, 110 with the marketing entity via the central facility 130. Persons of ordinary skill in the art will appreciate that the central facility server 132 may include a web-server to accommodate Internet and/or intranet-based communication with the user(s). Registration may include informing the marketing entity of the wireless telephone number so that a corresponding text message may be sent to the wireless telephone 400 that includes downloading instructions for the barcode image capture application, as discussed in further detail below. Similarly, even if the measurement entity sends the wireless telephone 108, 110 to the user(s), the telephone 108, 110 may not have the barcode image capture application installed thereon to save administrative costs of the measurement entity.

The user of the wireless telephone 108, 110 determines whether to participate in configuration activities or invoke the barcode image capture application (block 2506). If the user chooses to participate in configuration activities (block 2508), the wireless telephone 108, 110 and/or the central facility 130 will prompt the user with various screenshots and/or questions to facilitate configuration of the phone and/or the image capture application. If the user does not choose to participate in configuration activities (block 2506), then the wireless telephone 108, 110 determines whether the barcode image capture application has been invoked by the user (block 2510). If not, the wireless telephone 108, 110 waits until such a request is made and returns to block 2506. Persons of ordinary skill in the art will appreciate that the example wireless telephone 400 may also perform other functions including, but not limited to, sending calls, receiving calls, and/or capturing images with the camera-enabled features. If the barcode image capture application is invoked by the user (block 2510), then the wireless telephone 108, 110 executes the application (block 2512), as discussed in further detail below.

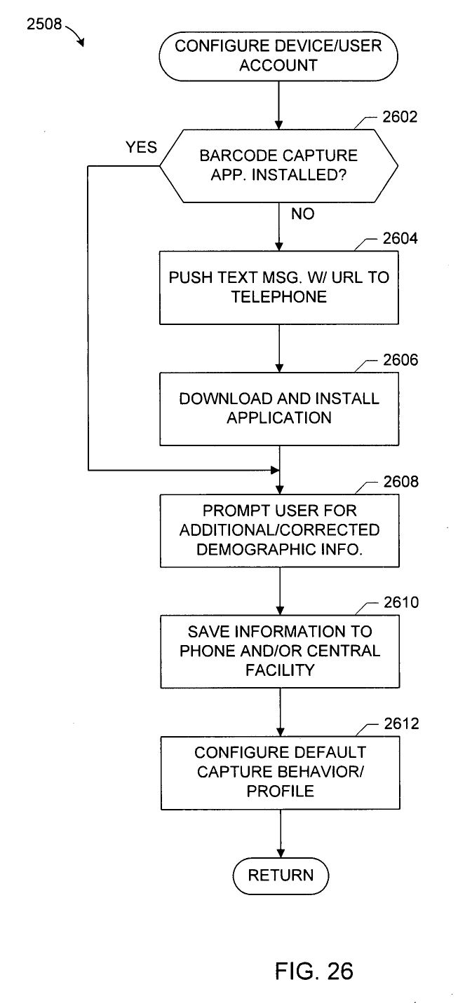

FIG. 26 illustrates additional detail of the example configuration activities (block 2508) described above. In the illustrated example, configuration activities are performed on the example wireless telephone 108, 110 and/or via a webpage provided and/or managed by the measurement entity. Some users may prefer to perform configuration activities on a home PC with a web browser because, for example, data entry on a full-size QWERTY keyboard is easier. On the other hand, some users may prefer not to be geographically constrained by a home PC and choose to perform configuration activities on the wireless telephone 108, 110 via the example keypad 408. In either case, configuration information provided by the user may be reconciled with the central facility 130 and/or the wireless telephone 108, 110. In other words, parity exists between information stored on the wireless telephone 108, 110 and the central facility 130. The example configuration activities 2508 determine whether the barcode image capture application is installed on the wireless telephone 108, 110 (block 2602). If not, the central facility 130, via the server 132, may push a text message to the wireless telephone 108, 110 (block 2604) that contains downloading and/or installation instructions. The user may follow such instructions to download and/or install the barcode image capture application on the wireless telephone 108, 110 (block 2606), and then begin to prompt the user for various user-specific information (block 2608). As discussed above, user-specific information of potential interest to a measurement entity may include, but is not limited to, age, gender, income, education, employment, race, occupation, and/or preferred language. Additionally, the configuration activities may include questions that determine the user's favorite stores, shopping locations, and/or product brand preferences. As discussed above, the various user-specific information (block 2608) may be entered by the user via the wireless telephone 108, 110 and/or on a home PC at the user's household 112 via a website provided and/or managed by the measurement entity via the central facility 130.

In the illustrated example, the user-specific information is saved to the wireless telephone 108, 110 and/or the database 134 of the central facility 130 (block 2610). Additionally, the user may configure the manner in which the barcode image capture application operates (block 2612). In other words, some of the various screenshots of FIGS. 5-18C and 20-24 may be eliminated to streamline the user's barcode image processing experience. For example, the user may configure a default “Purchase” option 1004 every time the barcode application is invoked, thereby eliminating the screenshot associated with FIG. 10. Similarly, the user may configure a default selection of “In Store” 1204 so that the screenshot associated with FIG. 12 is not presented to the user when making a purchase. In the event that more than one household member has access to the wireless telephone 108, 110, each user may configure a separate and unique profile that allows the wireless telephone 108, 110 to operate in a personalized manner. Upon completion of configuration activities, the example machine readable instructions 2500 may return to block 2506 to determine whether the user chooses to execute the barcode image processing application (block 2510), or update configuration settings (block 2508).

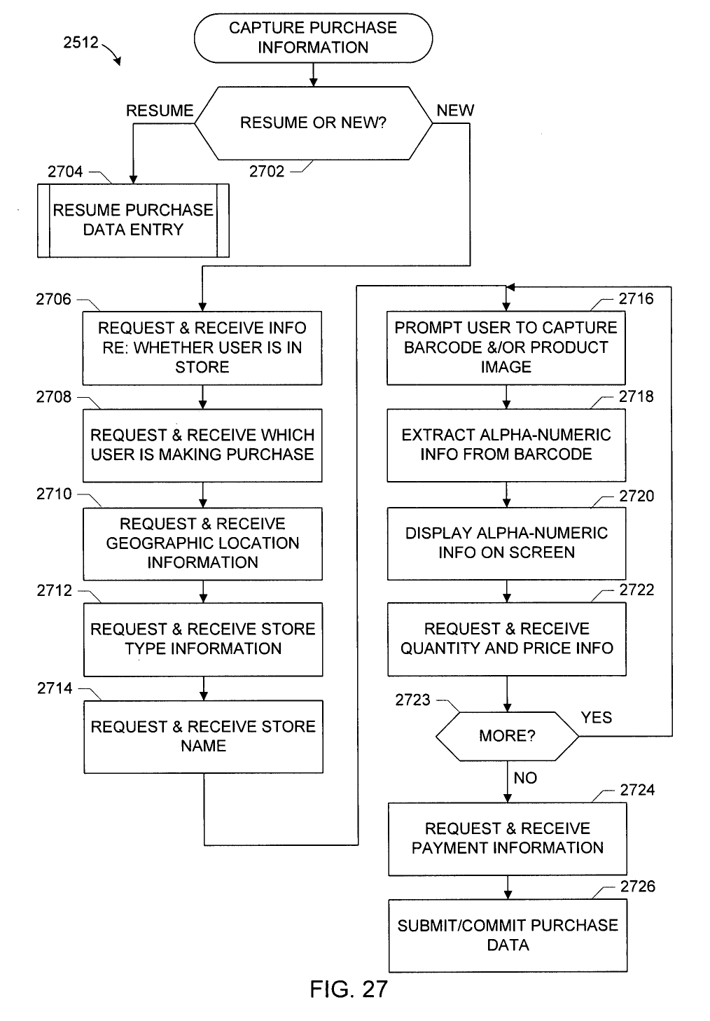

FIG. 27 illustrates additional details of the example barcode image processing application (block 2512) described above. Initially, the example process 2512 determines whether the user is making a new purchase or resuming a purchase that was previously started, but interrupted and/or suspended for some reason (block 2702). As described above, completion of purchase data entry may be interrupted by any number of reasons including, but not limited to, time constraints due to a crowded store, tending to children, and/or receiving a telephone call. As discussed in further detail below, the user may resume purchase data entry (block 2704) that was previously suspended. However, if the user chooses to initiate data entry for a new purchase, the barcode image capture application begins by requesting information from the user regarding whether the data entry is being performed in the store, or some other location (block 2706). As discussed above, the user may be presented with a screenshot similar to that shown in FIG. 12. After receiving the user's input and storing it to a memory of the example wireless telephone 108, 110, the example barcode image capture application requests information from the user regarding which user (e.g., John, Janet, or Junior) is making the purchase (block 2708). Because a single household 112 may contain more than one member (e.g., family members including a father, a mother, and a child), the application associates purchase behavior with the appropriate member by requesting such identification information. As described above, the request for user identification may be eliminated if there is only a single user for the wireless telephone 108, 110, or if the user has preconfigured a unique user profile and identified him or herself before starting the barcode image capture application. Persons of ordinary skill in the art will appreciate that a request to identify the user may be the very first question prompted by the application so that all subsequent steps may conform to a specific user profile, if any.

The example barcode image capture application next requests that the user enter location information (block 2710), such as the user's present state location, city location, zip code, and/or street address. Without limitation, example wireless telephones 108, 110 that include GPS functionality may avoid this question and determine such location information automatically. The location information that is received by virtue of user entry and/or GPS services is saved to the memory of the example wireless telephone 108, 110 (block 2710). Store type information may be requested by the user (block 2712), and saved to the memory of the wireless telephone 108, 110. For example, the user may select from any number of predetermined store categories in a list, such as the example list 1504 shown in FIG. 15. Additionally, the example barcode image capture application may prompt the user to enter the store name (block 2714) and store the selected name in the memory of the wireless telephone 108, 110. However, an example wireless telephone with GPS functionality may automatically determine the store in which the purchase is being made and eliminate this question and/or screenshot (See FIG. 16) from the user's view.

In the illustrated example, the camera 410 of the example wireless telephone 108, 110 is turned-on by the barcode image capture application (block 2716) and the user is asked to capture an image of a barcode on the product being purchased. Additionally, or alternatively, the user may capture an image of the product itself, particularly when the product does not have a barcode (e.g., fresh produce), or if the barcode is damaged (e.g., ripped, scratched, etc.). One-dimensional barcodes, such as UPC barcodes, may represent a numerical value that is associated with the product being purchased. The application extracts such (e.g., numerical) information from the barcode (block 2718) and displays such numbers on the screen (block 2720). Example software for rendering barcodes with camera phones is sold by Gavitec Mobiledigit®. For example, the memory of the example wireless telephone 108, 110 may include a lookup table of UPC numbers for the last fifty products purchased. The scanned barcode may be compared with a UPC number in the list so that, for example, if there is a match, additional questions may be triggered for the user. Questions may include, but are not limited to, “What prompted you to make this purchase?” Additionally, example answers may include, but are not limited to, “Please press 1 if you purchased this product because of a television advertisement, please press 2 for a magazine advertisement, or please press 3 if you purchased this product in response to a friend's recommendation.” Persons of ordinary skill in the art will appreciate that the memory of a portable device, such as the example wireless telephone 108, 110, may be limited to storing a relatively low number of barcode identification numbers. Accordingly, the application may transmit the extracted barcode indicia (e.g., a UPC number, an alphanumeric identification string, etc.) to the central facility 130 to perform a query on a larger database, such as the example database 134 connected to the server 132. Without limitation, the central facility may query other databases and/or Internet resources in an effort to find a match between the barcode identification information and an associated product. Persons of ordinary skill in the art will appreciate that one or more standards organizations may be chartered with the responsibility of registering a unique bar code for each product sold in a commercial market. For example, GS1 is a global organization dedicated to the design and implementation of global standards to improve efficiency in supply and demand chains on a global scale. As such, GS1 includes searchable databases to allow barcode identification and/or resolution.

In the illustrated example, the barcode image capture application requests quantity and/or price information from the user (block 2722). The application also asks the user whether there are additional products for which to capture barcode data (block 2723), in which case the example process 2512 returns to block 2716. Otherwise, the image capture application requests information relating to how the user paid for the product(s) (block 2724), and requests that the user submit/commit all entered purchase information to the central facility 130 (block 2726). In response to successful purchase data submission, the measurement entity may award the user with bonus points, free wireless minutes, third party vendor coupons, and/or other incentives (e.g., see FIG. 24).

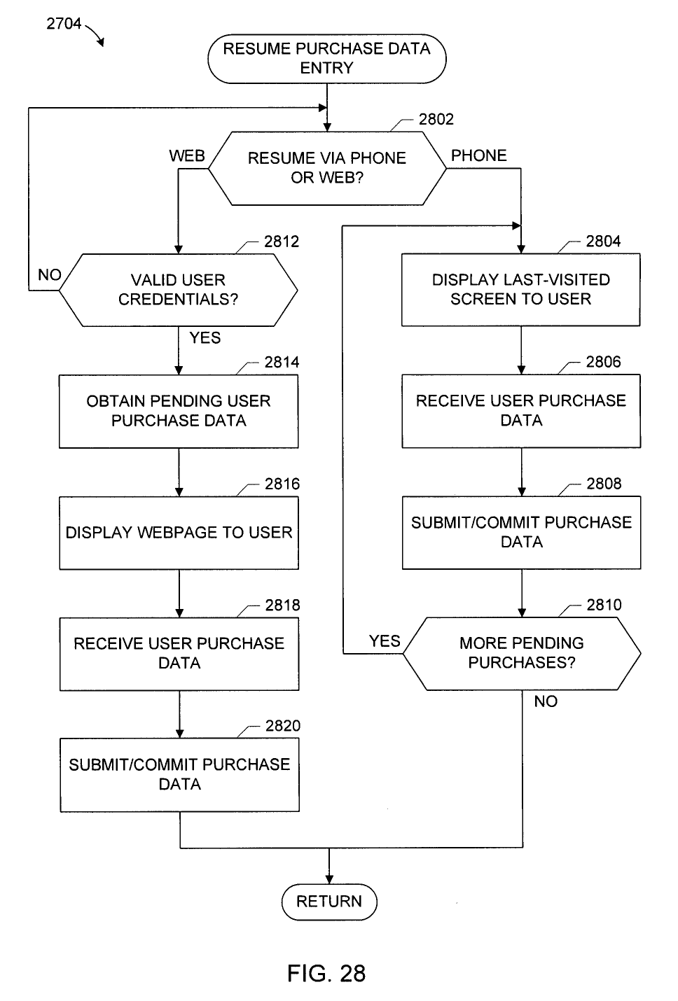

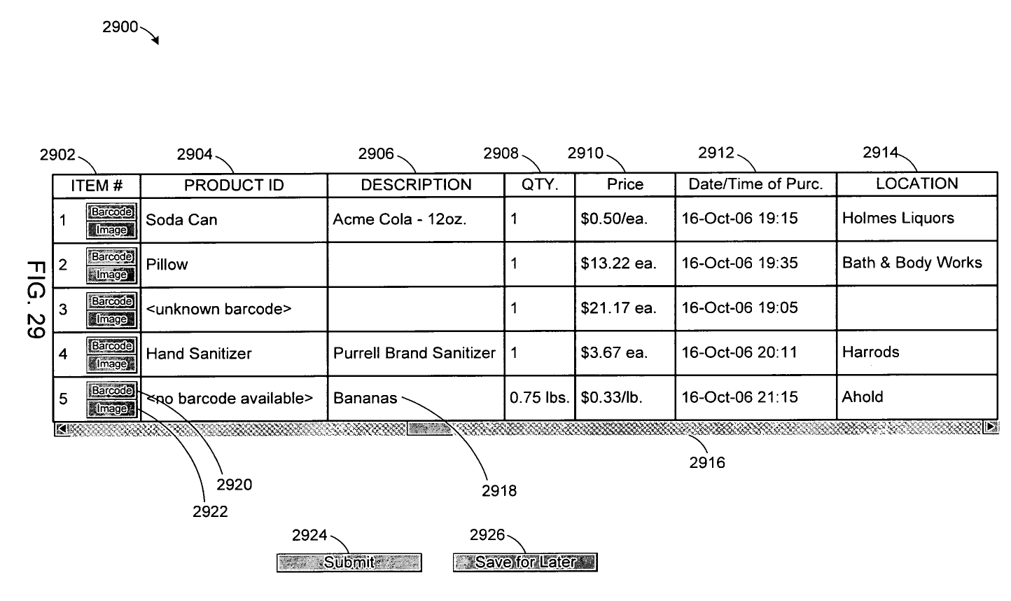

As described above, the user may be interrupted while the barcode image capture application is executing. Alternatively, the user may intentionally suspend the barcode image capture application based on, for example, an important phone call, time constraints due to a crowded store, and/or a child that needs attention. FIG. 28 is a flowchart representative of machine readable instructions that may be executed to resume purchase data entry after an interruption and/or manual suspension of the barcode image capture application. In the illustrated example, the operations described in connection with FIG. 28 are used to implement the operation of block 2704 of FIG. 27. Initially, the example resume purchase data entry process 2704 determines whether the user is completing/resuming purchase data entry via the wireless telephone 108, 110 or a web page (block 2802) facilitated by the central facility 130 (e.g., the server 132, a web server, etc.). If the user is resuming data entry via the example wireless telephone 108, 110, then the barcode image capture application presents the user with the same screen that was being viewed during the prior interruption and/or suspension (block 2804). In the illustrated example process of FIG. 28, the wireless telephone 108, 110 receives additional purchase related information (block 2806) by stepping the user through the remaining display screens and/or instructions, as discussed in view of FIGS. 5-18C and 20-24. Upon completion of data entry, the wireless telephone 108, 110 receives permission from the user to transmit collected purchase data to the central facility 130 (block 2808), and the barcode image capture application determines whether there are additional pending purchases for which user input is required (block 2810). For example, the user may have suspended the barcode image capture application on several occasions during a shopping trip. As a result, the example wireless telephone 108, 110 stores the pending purchase data in a memory, which includes stored details of the last screen the user was viewing before the interruption and/or manual suspension occurred.

In the event that the user chooses to resume the product purchase from an Internet connected web browser, such as a home PC at the example household 112, the central facility receives user authentication credentials from the website visitor (block 2812). If the user authentication credentials are not valid, the central facility 130 prevents further access. However, if the user credentials are valid, the server 132 of the central facility 130 obtains the purchase data associated with product purchase data interrupted by a manual suspension and/or interruption (block 2814). For example, if the user receives an important phone call while following screen-prompt instructions provided by the example barcode image capture application, the application may automatically forward saved data to the central facility 130 and store it in the database 134. As a result, if the user resumes the process of entering the purchase data from, for example, a home PC instead of the wireless device 108, 110, then the central facility may transmit instructions to the wireless device to erase the corresponding data in the memory of the wireless device 108, 110 that was associated with the suspended/interrupted process.

In the illustrated example, the user is presented with a web page populated with a list of product purchases that have not yet been completed by the user (block 2816). As discussed in further detail below, the example web page presents the user with any number of pending product purchases as a result of manual suspension and/or interruption. However, the user may also intentionally utilize the example camera-enabled wireless telephone 108, 110 in a manner in which all purchases begin at a store with an image capture and subsequent suspension of the barcode image capture application. Each time the user captures an image of a product that was purchased in a store, or will be purchased in the store, the wireless telephone 108, 110 associates a time and/or date stamp with the captured image to log when the purchase was made. As a result, the user does not have to consume any time with data entry while in the store and/or may enter such purchase data at a more convenient time (block 2818). Additionally, the user may prefer to enter as much purchase-related data as possible from a full-size QWERTY keypad rather than the example keypad 408 associated with the example wireless telephone 108, 110. When the user completes data entry via the example web page, discussed below and illustrated in FIG. 29, the user may submit the entered purchase data to the central facility 130 (block 2820).

FIG. 29 illustrates an example web page 2900 that is provided by the server 132 of the central facility 130. As discussed above, the central facility may be communicatively connected to the Internet/intranet 128 and/or the wireless network 126 of any particular wireless service provider. Additionally, the example household 112 may have access to the Internet 128 via a digital subscriber line (DSL), cable modem, telephone modem, wireless service provider-based Internet access, and/or satellite-based Internet access. Persons of ordinary skill in the art will appreciate that the example web page 2900 may be provided by a web server, such as the example server 132 of the central facility and/or facilitated by a third party web development agency under contract to build and/or operate the example web page 2900.

In the illustrated example web page 2900 of FIG. 29, the user is presented with several columns of data including an item number column 2902, a product identification column 2904, a description column 2906, a quantity purchased column 2908, a price column 2910, a date/time of purchase column 2912, and a location column 2914. Persons of ordinary skill in the art will appreciate that the example web page 2900 of FIG. 29 is illustrative and not exhaustive. In particular, the example web page 2900 also includes a horizontal scroll bar 2916 to accommodate user access of additional columns of additional data types of interest to the measurement entity. Each row of the example web page 2900 represents an instance where the user initiated the barcode image capture application to record details of a product purchase, but was interrupted and/or manually suspended the application for alternate reasons.

The example product identification column 2904 includes known data about the product as a result of processing the captured image. For example, the example camera-enabled wireless telephone 108, 110 may have captured a one-dimensional barcode and processed the image to extract the digits “352800658807.” Additionally, the lookup table in the memory of the wireless telephone 108, 110 may have included those digits associated with the term “hand sanitizer.”

The example Product Description column 2906 includes additional detailed data about the product and may be edited by the user. For example, in row 4 (item #4), the description column 2906 includes the text “Hand Sanitizer by Purell®”. However, row 5 (item #5) illustrates that the user purchased an item that did not include a barcode, thereby resulting in the text “no barcode available” in the product identification column 2904. Example row 5 (item #5) may represent, for example, that the user purchased fresh produce having no barcode printed thereon, such as bananas. The user may enter the term “bananas” in a text box 2918 to identify the item purchased. To minimize situations in which the user forgets details about the item purchased at the store, particularly items without a barcode, the user may select a “View Barcode” button 2920 and/or a “View Product” button 2922. As discussed above in view of FIG. 27, the example wireless telephone 108, 110 may provide prompts to the user to capture an image of the product in the event that no barcode is printed thereon, which may be used by the user when completing purchase data entry and/or used by the marketing entity for data analysis. In the illustrated example, the “View Barcode” button 2920 for row 5 (item #5) is grayed-out because the product that was purchased (i.e., bananas) did not have a barcode. However, upon the user selecting the “View Product” button 2922, the user is presented with an image of the product purchased, thereby refreshing the user's memory.

After the user enters product purchase details for the remaining rows of the example web page 2900, a “Submit” button 2924 may be selected to commit the purchase data to the central data facility 130. Alternatively, the user may select a “Save for Later” button 2926 in case additional time is needed to complete purchase data entry.

FIG. 30 is a block diagram of an example processor system that may be used to execute the example machine readable instructions of FIGS. 25-29 to implement the example systems and/or methods described herein. As shown in FIG. 30, the processor system 3010 includes a processor 3012 that is coupled to an interconnection bus 3014. The processor 3012 includes a register set or register space 3016, which is depicted in FIG. 30 as being entirely on-chip, but which could alternatively be located entirely or partially off-chip and directly coupled to the processor 3012 via dedicated electrical connections and/or via the interconnection bus 3014. The processor 3012 may be any suitable processor, processing unit or microprocessor. Although not shown in FIG. 30, the system 3010 may be a multi-processor system and, thus, may include one or more additional processors that are identical or similar to the processor 3012 and that are communicatively coupled to the interconnection bus 3014.

The processor 3012 of FIG. 30 is coupled to a chipset 3018, which includes a memory controller 3020 and an input/output (I/O) controller 3022. As is well known, a chipset typically provides I/O and memory management functions as well as a plurality of general purpose and/or special purpose registers, timers, etc. that are accessible or used by one or more processors coupled to the chipset 3018. The memory controller 3020 performs functions that enable the processor 3012 (or processors if there are multiple processors) to access a system memory 3024 and a mass storage memory 3025.

The system memory 3024 may include any desired type of volatile and/or non-volatile memory such as, for example, static random access memory (SRAM), dynamic random access memory (DRAM), flash memory, read-only memory (ROM), etc. The mass storage memory 3025 may include any desired type of mass storage device including hard disk drives, optical drives, tape storage devices, etc.

The I/O controller 3022 performs functions that enable the processor 3012 to communicate with peripheral input/output (I/O) devices 3026 and 3028 and a network interface 3030 via an I/O bus 3032. The I/O devices 3026 and 3028 may be any desired type of I/O device such as, for example, a keyboard, a video display or monitor, a mouse, etc. The network interface 3030 may be, for example, an Ethernet device, an asynchronous transfer mode (ATM) device, an 802.11 device, a digital subscriber line (DSL) modem, a cable modem, a cellular modem, etc. that enables the processor system 3010 to communicate with another processor system.

While the memory controller 3020 and the I/O controller 3022 are depicted in FIG. 30 as separate functional blocks within the chipset 3018, the functions performed by these blocks may be integrated within a single semiconductor circuit or may be implemented using two or more separate integrated circuits.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method to collect point-of-purchase data comprising:
receiving purchased product information from a camera-enabled telephone;
receiving at least one of user demographics or user identification information from the camera-enabled telephone; and
receiving point-of-purchase information from the camera-enabled telephone.

2. A method as defined in claim 1, wherein the purchased product information comprises machine readable indicia.

3. A method as defined in claim 2, wherein the machine readable indicia comprises at least one of a universal product code, a one-dimensional barcode, or a two-dimensional barcode.

4-6. (canceled)

7. A method as defined in claim 1, wherein the user identification information is indicative of a purchaser of at least one of merchant goods or merchant services.

8. (canceled)

9. A method as defined in claim 1, wherein the point-of-purchase information comprises a purchase location.

10. A method as defined in claim 9, wherein the purchase location comprises at least one of a city, an address, or a zip code.

11. A method as defined in claim 10, further comprising determining at least one merchant in a location associated with at least one of the city, the address, or the zip code.

12. A method as defined in claim 9, wherein the purchase location comprises global positioning system (GPS) information.

13-16. (canceled)

17. A method as defined in claim 1, wherein the point-of-purchase information comprises at least one of a date of purchase or a time of purchase.

18. A method as defined in claim 1, wherein the point-of-purchase information comprises a quantity associated with the purchased product information.

19. A method as defined in claim 1, wherein the point-of-purchase information comprises at least one of a payment method, a promotional code, or a coupon.

20-21. (canceled)

22. A method as defined in claim 1, further comprising uploading image capture software to the camera-enabled telephone, the image capture software to enable the camera-enabled telephone to obtain the purchased product information.

23-24. (canceled)

25. A method as defined in claim 1, further comprising image capture software to facilitate point-of-purchase data acquisition on the camera-enabled telephone and to read at least one of a universal product code (UPC) or a barcode with the camera-enabled telephone.

26-34. (canceled)

35. A method as defined in claim 1, further comprising mailing the camera-enabled telephone to a user upon user agreement to participate in a market research project.

36-57. (canceled)

58. A wireless telephone to collect point-of-purchase data comprising:
a camera to capture an image of a barcode identifying a product;
a display to render the image of the product barcode;
a user interface to facilitate entry of point-of-purchase data; and
an extractor to extract product identification information from the image of the product barcode.

59. A wireless telephone as defined in claim 58, wherein the extractor associates the point-of-purchase data with the product identification information.

60. A wireless telephone as defined in claim 58, further comprising a proximate store list, the list comprising a plurality of stores arranged in an order based on a proximity between the wireless telephone and at least one of the plurality of stores.

61. A wireless telephone as defined in claim 58, wherein the order of the stores in the proximate store list is arranged based on at least one of an address, a city, or a zip code.

62. A wireless telephone as defined in claim 61, further comprising a global positioning system (GPS) receiver to identify a location of the wireless telephone.

63. A wireless telephone as defined in claim 62, wherein the extractor disables the GPS receiver when the wireless telephone is located at a user household.

64. (canceled)

65. A wireless telephone as defined in claim 58, further comprising a transmitter to transmit the product identification information and point-of-purchase data to a market research entity.

66. A wireless telephone as defined in claim 58, further comprising a receiver to receive store data from a market research entity.

67-69. (canceled)

70. A method to collect point-of-purchase data with a camera-enabled wireless telephone comprising:
receiving location information;
capturing an image of a barcode of a purchased product with a camera-enabled wireless telephone;
extracting product identification information from the barcode; and
associating the product identification information and location information with a purchase date.

71. (canceled)

72. A method as defined in claim 70, wherein the location information comprises global positioning system (GPS) coordinates.

73. (canceled)

74. A method as defined in claim 70, further comprising generating a proximity list of merchants arranged in the list based on a proximity to the location information.

75. A method as defined in claim 74, further comprising receiving a merchant identity based on a selection of the list and transmitting the merchant identity, the product identification information, and the purchase date information to a central facility from the wireless telephone.

76. A method as defined in claim 70, wherein extracting product identification information comprises extracting alpha-numeric data associated with a universal product code (UPC).

77. A method as defined in claim 70, further comprising receiving an invitation to install a barcode capture application on the camera-enabled telephone.

78-79. (canceled)

80. A method as defined in claim 70, further comprising configuring the camera-enabled telephone with user information, the user information comprising at least one of a user name, a user age, a user gender, a user education, a user occupation, a user income, or a user home address.

81-82. (canceled)

83. A method as defined in claim 70, further comprising requesting a user of the camera-enabled wireless telephone to enter the location information at the point-of-purchase.

84-95. (canceled)
